(19) United States
(12) Patent Application Publication
(10) Pub. No.: US 2004/0104245 A1
(43) Pub. Date: Jun. 3, 2004

(54) Plastic closing device with a piercing element

(76) Inventor: Werner Fritz Dubach, Maur (CH)

Correspondence Address: Pauley Petersen Kinne & Erickson, Suite 365, 2800 West Higgins Road, Hoffman Estates, IL, 60195, US

(21) Appl. No.: 10/398,108

(22) PCT Filed: Sep. 27, 2001
(86) PCT No.: PCT/CH01/00582

(30) Foreign Application Priority Data
Oct. 3, 2000 (CH) 193900
Nov. 9, 2000 (CH) 218100

(51) Int. Cl. B67D 5/00

(52) U.S. Cl. 222/83

(57) ABSTRACT

The invention relates to a closing device (1) for a container (B) that comprises a bung-type lower part (2) with a cylindrical pour spout (20). The cylindrical pour spout has a female thread in which a cylindrical piercing element (3) that is open to both sides and that is provided with a male thread is retained by a screw connection. A screw cap (4) can be placed on the lower part, said screw cap being provided with driver means (44, 45) that interact with driver means (34) in the piercing element (3). A fine-pitch thread is provided between the screw cap (4) and the lower part and a coarse-pitch thread between the lower part and the piercing element. The combined screw/translational motion of the piercing element and the selected threads produce a highly effective cutting motion.

The present invention relates to a closure device made of plastic, which can be applied over a location which can be punctured of a closed container in accordance with the preamble of claim 1.

Various containers, particularly for storing flowable media, are available in commerce, wherein prior to opening them it is necessary to pierce a foil, or membrane, or even the container wall itself before the liquid medium can be removed from the container. For example, such containers are so-called soft cartons made of single- or multi-layered foil or coated cardboard, on which a closure device has been glued or welded, wherein the closure device comprises a screw cap. Closure devices for such cartons have a lower element with a cylindrical pouring spout with an outer thread and a lower flange on the edge for fastening on the soft carton. Before the contents can be taken out of the said soft carton it is necessary, on the one hand, to unscrew the screw cap from the lower element and on the other hand to puncture the container wall in the area of the pouring spout. The closure device has an integrated piercing element for puncturing the container wall in the area of the container opening.

Two systems in particular are known here. With one system the screw cap is removed in a first step, and in the second step the piercing element is moved downward by the user for puncturing the container wall. Typical representatives of this version are known, for example, from EP-A-0 543 119 and U.S. Pat. No. 5,297,696. So that the piercing element of such a closure device can be reasonably operated, the cylindrical pouring spout must be provided with a lateral recess, which extends in the axial direction and approximately corresponds to the width of a finger. This known attainment version is relatively simple in construction, however, it has the disadvantage that, on the one hand, the pouring properties of such a closure are poor and, on the other hand, there is a great danger that in the course of actuating the piercing element the finger comes into contact with the liquid contents. One the one hand, this leads to soiling of the finger, and to the contamination of the liquid contents on the other hand. This is particularly disadvantageous, since the containers of interest here are especially used for beverages, whose ability to keep is considerably reduced by contamination.

In a second version, here of particular interest, there is an interactive effect between the screw cap and the piercing element. In the most frequent cases by far, the piercing element is pushed down through the container wall with the help of the screw cap. For this purpose, the screw closure is in an upwardly displaced position in relation to the lower element prior to first opening, which in most cases is bridged by a security strip. Accordingly it is necessary to first remove the security strip, whereafter the closure is screwed down completely in the course of which the screw cap, as well as the piercing element seated in the pouring spout are moved downward. Therefore the soft carton is punctured and opened in the course of complete closure by means of the screw cap. In a third step it is now necessary to completely unscrew the screw cap before the contents are freely accessible and can be poured out. A typical representative of this closure version is known from WO 96/11850, for example. A closure device in accordance with WO 99/64315 operates in a similar manner. With this device the piercing element has two sections of thread in different directions of lead. In a first screwing movement the piercing element is pushed through the container wall, and thereafter the screw cap is unscrewed from the piercing element in the opposite turning direction.

While closures of this type are relatively new in connection with soft cartons, such closure devices are already known in various embodiments in an analogous construction for containers in the form of bottles, whose container neck is sealed by means of a membrane or foil. Closure devices of this type have not been successful in commerce. Besides frequently occurring sealing problems, the main problem is seen to be that the opening process does not agree with the habits of the consumer. It is therefore necessary to place elaborate instructions of how to open the carton on it. This is not only undesirable, but experience has shown that these instructions are hardly observed and that the consumer reads these instructions only after he already has destroyed the closure or rendered it ineffective.

On the basis of this knowledge, WO 99/42375 proposes a device in which a piercing element cooperates interactively with a screw cap in such a way that, in the course of simple unscrewing the screw cap, the piercing element is simultaneously moved in such a way that it is conveyed downward and punctures the carton wall. This closure device is absolutely simple to operate and accordingly is comfortable for the consumer. However, in connection with this closure device the fact, that the piercing element must be applied so it adheres to the carton wall, is problematic. The punctured portion of the carton wall is caught on the piercing element. The edges of the carton wall remaining on the piercing element remain fixedly connected with it, even after first opening. The piercing element itself remains in the screw cap and is taken out when the screw cap is opened. Since paper or cardboard is a part of most soft cartons, the destroyed container wall, which is fixedly glued to the piercing element, comes again and again into contact with the contents of the container, on the one hand and, on the other, is conveyed outward again at each opening and can be repeatedly contaminated in the process, and residue from the liquid adhering to it can also be contaminated or oxidize, and thereafter come again into contact with the contents when the screw cap is closed. Besides these undesirable use properties, this closure device in particular has the enormous disadvantage that it is extremely tricky and expensive to mount. The reason for this is that, on the one hand, the lower element and, on the other hand the piercing elements, must be glued or welded to the container wall. While the flange of the lower element can be welded on, depending on the carton material, the piercing element must be glued on in every case. If insufficient adhesive is applied, the piercing element is torn off the carton wall during opening without the carton necessarily being opened. If too much adhesive is used, adhesive connections between the piercing element and the lower element are formed and the screw cap can hardly be screwed on without the threads being stripped in the process.

Finally, a closure device, which constitutes the preamble of claim 1, is known from EP-A-0 328 652. It is extremely simple to operate, since in the course of unscrewing the screw cap for the first time the piercing element is moved linearly downward and in this way the membrane or the container wall is punctured.

Soft cartons necessarily must have a pre-punched predetermined opening spot. Such a predetermined opening spot is achieved by means of an impression stamping, by which the foil or the foil connection is only partially punched without achieving penetration, so that the piercing element makes possible the complete puncturing with little force. This is an extremely tricky punching operation, accordingly, the partial punching is relatively often too ineffective, so that required force the piercing element must generate is very large.

With the known solution in accordance with EP-A-0 328 652, the axially acting force is exerted on the piercing element by the screw cap, and the screw thread of the screw cap must be able to absorb this force. Accordingly, the screw thread on the cylindrical lower element and on the inner surface of the jacket wall of the screw cap must be made strong, i.e. with a large lead.

However, this is undesirable for several reasons. Such a screw thread as a whole requires a more solid construction with increased wall thickness, which results in an additional weight of one to three grams even with relatively small closure devices. At the number of pieces required here of more than 10⁹ pieces/year, a savings of material in the amount of more than 1000 tons of plastic material results, if a reduced lead can be realized.

With the solutions known today, and in particular also with the solution in accordance with WO 99/62776, or the above mentioned EP-A-0 328 652, the entire translatorial movement of the piercing element can be practically distributed only to a rotatory movement over 180° of the screw cap. Accordingly, the required force for the first actuation of the screw cap is large and depends greatly on the toughness of the material the piercing element has to puncture.

It is the object of the present invention to create a closure device of the type mentioned at the outset, wherein the force transfer from the screw cap to the piercing element can be realized by means of small axial forces acting on the screw cap.

This object is attained by a closure device having the features of claim 1.

A preferred embodiment of the subject of the invention is shown in detail in the drawings. Shown are in:

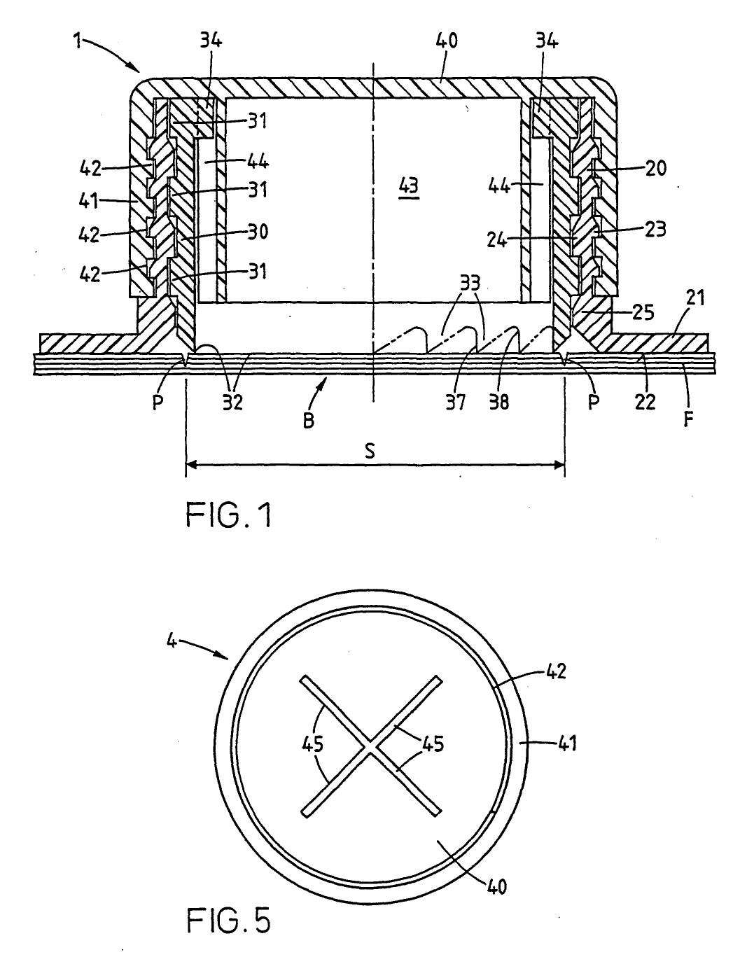

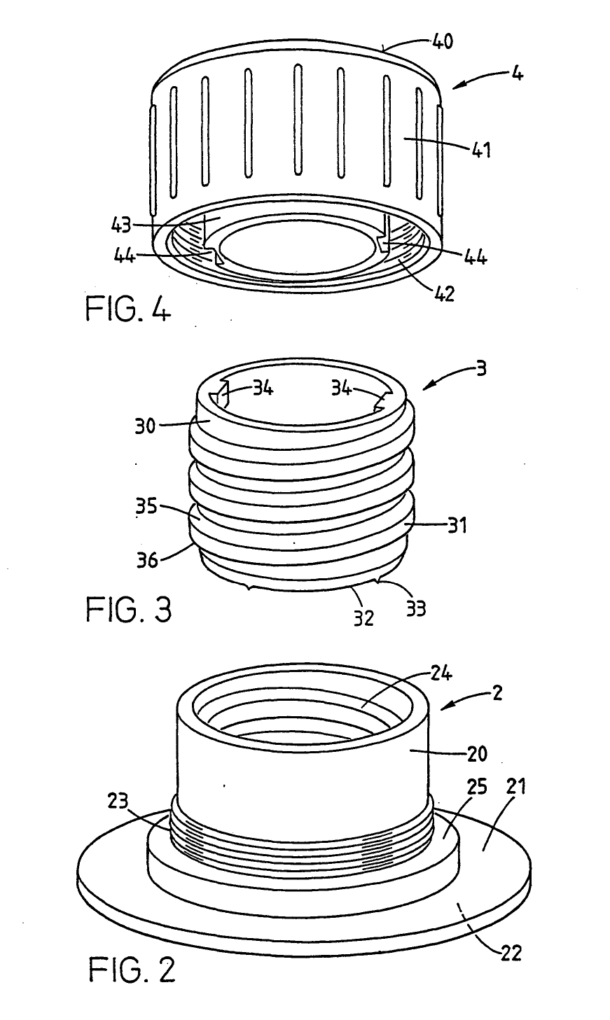

FIG. 1, a vertical diametrical section through the closed closure device prior to first use, while FIGS. 2 to 4 show the details of a similar closure device in perspective positions, wherein

FIG. 2 shows the lower element in a plan view obliquely from above,

FIG. 3, the piercing element also in a plan view slightly from above, and

FIG. 4, the screw cap in a view slightly from below.

FIG. 5 shows a variation of the screw cap in a view from above, looking on the interior surface of the screw cap.

The closure device, identified by 1 as a whole, is visible in FIG. 1 and is represented there in vertical diametrical section. The position shown there shows the closure device 1 fastened on a container B. In this case the container is a soft carton made of a foil or multi-layer foil F. Soft cartons are understood to be containers made from coated cardboard or a laminated foil, which have a predetermined opening spot S which has been provided by impression stamping P. Certain layers of the foil F are cut by means of this impression stamping, while the innermost located layers or layer remain unaffected.

However, the solution in accordance with the invention can also be employed with soft cartons in which an appropriate opening has already been punched. While with the first variation the lower element 2, still to be described, is welded or glued to the outside of the foil F, fastening with the second variation takes place by welding or gluing to the outside or inside, wherein in the latter case the lower element 2 extends through the already provided opening. In the last two variations mentioned, an appropriate membrane is then provided, which must be pierced.

Without it being necessary to represent such a solution, it is obvious to one skilled in the art that the solution in accordance with the invention can also be realized in a way in which the lower element 2 represents an integral component of the container. In this case the lower element 2 corresponds to an appropriately designed container neck.

The following detailed description of a preferred embodiment refers to FIGS. 1 to 4. FIGS. 2 to 3 here represent the three main components in an exploded view.

The lower element 2 is shown in detail in FIG. 2. The lower element 2 is in the shape of a spout. It consists of a flange 21, whose underside or top constitutes a welding or gluing surface 22. In this way the connection of the closure device 1 with the container B is provided by means of the flange 21. The flange 21 is formed flush as one piece on the lower edge of the cylindrical pouring spout 20. The cylindrical pouring spout 20 has a rough-pitch multiple-start inner thread 24 with a relatively low lead of the turns. The cross section of the thread turns is preferably trapezoidal. Here, the flank of the thread turns which is on top in the installed position is inclined, while the lower flank projects practically at right angles away toward the interior from the cylindrical wall of the pouring spout 20. On the one hand, this permits an improved pull-out of the core from the inj ection mold during production and, on the other hand, an easier ratchet-like overlapping of this thread with the outer thread of the piercing element 3, which has an outer thread which is correspondingly oppositely threaded. This will be discussed in what follows. The multiple-start of the thread permits the realization of an increased force transfer on the one hand, and on the other a less steep course of the thread, while at the same time positioning during the assembly is less tricky.

On the outside of its cylindrical jacket wall, the pouring spout 20 has an outer thread 23. While in the embodiment in accordance with FIG. 1 this outer thread extends over practically the entire height of the pouring spout 20 and has a conventional thread, a preferred embodiment is represented in FIG. 2, in which the outer thread is only arranged in the lower area and is designed as a fine-pitch thread. Such a fine-pitch thread not only saves material, but has the additional advantage that again no exact angle-related positioning is required during assembly. The fine-pitch thread picked here can be selected because, in contrast to the solutions in the prior art, the axially occurring forces during the actuation of the piercing element need not be absorbed by the screw cap 4. Only radial movements are exerted on the piercing element by the screw cap 4, wherein the thread between the screw cap 4 and the lower element 2 remains practically unstressed. A ring-shaped detent bead 25 is formed between the outer thread 23 and the flange at the lower part of the pouring spout 20. On the one hand, this detent bead 25 absorbs the forces acting on the lower element 1 in the course of pressing down the screw cap 4. In this way the screw cap 4 can be directly pressed down until it is in contact with the detent bead 25. However, the detent bead 25 can additionally have positive connecting means, not represented here, which can cooperate with a security strip on the screw cap 4. Such a security strip is not the subject of the invention here and has therefore been omitted from the drawings in order to make them less crowded.

A correspondingly designed piercing element 3 fits into the pouring spout 20 of the lower element 2. The piercing element 3 is in the shape of a cylindrical piece of tubing. This piece of tubing is formed by a cylindrical wall 30 provided with an outer thread 31, whose shape has been appropriately matched to the inner thread 24 of the lower element 2. This outer thread 31 also has a relatively low lead of the turns. The turns of the again multiple-start thread 31 also have a trapezoidal cross section. In contrast to the inner thread 24, the upper flank 35 here extends very steeply, or respectively almost vertically, in relation to the cylindrical wall 30. The thread flank 36 which is on the bottom in the installed state, however, is relatively strongly inclined. Here, too, this design shape permits on the one hand an improved removal from the injection mold and, on the other hand, an easier ratchet-like introduction of the piercing element 3 into the lower element 2. The lower edge of the piercing element 3 is designed as a cutting edge 32. Accordingly, the cylindrical wall 30 is shaped so it inclines from the outside to the inside and forms a sharp-edge cutting edge. Perforating teeth 33 can be additionally formed on the cutting edge 32.

On its inner surface, the cylindrical wall 30 has at least one catch element 34 protruding toward the center. Depending on the design, however, it is also possible to attach two or four such catch elements 34. In the embodiment in accordance with FIG. 3, these catch elements 34 are designed as cams, which have an approximately rectangular cross section. However, the catch elements 34 can also be embodied as ribs, which extend continuously in the axial direction.

In a particularly preferred variation, also not represented here, the lower element 2 and the piercing element 3 can be produced, axially aligned in relation to each other in the vertical direction, in one piece, wherein they are connected at the place where they are joined via several predetermined breaking points. In this way the assembly can be performed particularly easily by merely pressing the two elements into each other. An alignment of the two elements can be omitted, since they have already been produced correctly on top of each other and with the correct angular position to each other during their manufacture.

The screw cap 4 is represented in FIG. 4. It consists of a cover face 40 and the circumferential jacket wall 41. The inner thread 42 is formed on the inside of thejacket wall 41 and cooperates with the outer thread 23 on the pouring spout 20. Accordingly, this thread is also designed as a fine-pitch thread. An annular wall 43 is formed, centered on the cover face 40. This is of such a size that it can be placed with a defined clearance into the interior space of the piercing element 3. The annular wall 43 does not have a sealing function, but is substantially used for driving the piercing element 3. Accordingly, the annular wall 43 has positive connecting means, which can cooperate with the catch elements 34 at the inner wall of the cylindrical wall 30. One the one hand, these positive connecting means can be a catch groove 44, in which the catch element 34 can slide, or the positive connecting means can be designed as a catch rib 45. In this case the catch rib 45 rests laterally on the catch element 34 during actuation. As already mentioned, the catch element can accordingly be designed either as a cam or as a longitudinal rib.

However, the positive connecting means can also be designed without the annular wall 43. Such a solution is represented in FIG. 5, wherein the interior of a screw cap 4 is represented in a view from below. Here, too, the jacket wall 41 with the inner thread 42 is formed adjoining the cover face 40. But here two intersecting walls, extending vertically on the cover face 40, are formed, instead of an annular wall 43, and define four catch ribs 45. This solution is used in particular with closure devices of narrower diameter.

As already mentioned, the closure device in accordance with the invention can be applied to a soft carton, wherein the connection between the soft carton and the closure device 1 is provided via the lower element 2. It is also possible, and has already been mentioned, for the lower element 2 itself to constitute a part of the container. Finally, it can also be useful to design the lower element as an adapter in order to make the connection with an existing pouring spout of any arbitrary container.

As also already mentioned, the piercing element 3 can be formed in one piece with the lower element 2. In that case the two elements are aligned flush with each other. Such a solution can be realized in that the piercing element is formed above the lower element 2, however, a reverse arrangement is also possible, wherein the piercing element 3 is formed below the pouring spout 20 and is aligned with it via predetermined breaking points. The latter variation has the advantage that the design of the cutting edge is not affected by this. As shown for example in the right half of FIG. 1, the cutting edge 32 can of course be designed with teeth. The design of the cutting edge 32, whether with or without perforating teeth 33, or with a straight or serrated cutting face, will substantially depend on the material from which the container B, or the membrane which is to be opened by the piercing element, is made.

While up to now the connection between the lower element 2 and the piercing element 3 has always been described as a thread, it should be pointed out here that this is not absolutely required. These positive connecting means at the cylindrical wall of the piercing element and on the inner wall of the spout 20 can also be designed as helical slideways. Corresponding to this, the positive connecting means at the cylindrical pouring spout would be designed as an approximately diametrically opposed, helical guide curve cut into the wall of the pouring spout. In order not to cause a point-like transmission, the mentioned slideway and the guide curve would be matched to each other in such a way that the two rest flat on each other.

As already mentioned, the design of the cutting edge can be specifically matched to the material to be punctured. Three different areas of effect can be defined by means of such a specific embodiment. The first effective area consists of the perforating teeth 33, which in a first step cause the perforation of the material. Cutting areas 37 will be provided, which directly adjoin the perforating tooth in the direction of rotation, and cause a cutting penetration of the material. Finally, the cutting edge can make a transition into an obtuse, widened area 38, which is the farthest removed from the perforating tooth in the axial direction and is only used for pushing the cut container wall or membrane out of the area of the pouring opening.

As already mentioned, the great advantage of the solution in accordance with the invention lies in that practically no forces act in the axial direction on the screw cap when it is operated. This advantage also applies in respect to the use of a security strip. Normally security strips, which are separated from the screw cap directly in the course of unscrewing, are connected with the latter by means of appropriate predetermined breaking points, and these predetermined breaking points must be severed by exerting a force in the axial direction, which occurs in the course of unscrewing the cap. Since in connection with known solutions for a closure device of the type of interest here this force acts together simultaneously with the axial force to be exerted on the piercing element, or is added to it, the total force required for opening was enormously large. A use of a fine-pitch thread would be inconceivable from the start.

The essential principle of the solution according to the invention lies in the new type of kinematics. Instead of achieving the axial movement of the piercing element by means of the screw cap as previously, it is achieved here by the screwing motion between the piercing element 3 and the lower element 2.

List of Reference Symbols

1 Closure device

2 Lower element

3 Piercing element

4 Screw cap

5 Pouring spout

21 Flange

22 Welding or gluing surface

23 Outer thread

24 Inner thread

25 Ring-shaped detent bead

30 Cylindrical wall

31 Outer thread

32 Cutting edge

33 Perforating teeth

34 Catch element

35 Upper flank

36 Lower flank

37 Cutting area

38 Displacement area

40 Cover face

41 Jacket wall

42 Inner thread

43 Annular wall

44 Catch groove

45 Catch ribs

B Container

F Foil or multi-layered foil

P Impression stamping

1. A closure device (1) of plastic, which can be applied over a spot, which can be punctured, of a closed container (B), consisting of a spout-shaped lower element (2) with a cylindrical pouring spout (20), and is or can be connected with the container, and a screw cap (4), which can be screwed on the lower element (2), as well as a cylindrical piercing element (3), open at both ends in the axial direction and displaceably seated in the lower element, in which means (44, 45) are provided in the screw cap (4) which, in the course of an unscrewing movement act on the piercing element, wherein the latter is moved downward into the container through the spot (S) which can be punctured, characterized in that on its cylindrical inner wall (30) the piercing element (3) has at least one catch element (34), which acts together with at least one catch rib (45) or catch groove (44) provided in the screw cap (4) and which in the course of a rotating movement of the screw cap (4) puts the piercing element (3) into a rotating movement, and that positive connecting means (24, 31) are provided between the cylindrical pouring spout (20) of the lower element (2) and the cylindrical piercing element (3), which move the pouring spout (20) downward in a helical manner during the first unscrewing movement of the screw cap.

2. The closure device in accordance with claim 1 for use on a soft carton (F), characterized in that the cylindrical pouring spout (20) with an outer thread is designed with a lower flange (21) on the edge for fastening to a soft carton, and that the spot which can be punctured is an area (S) in the container wall located below the pouring opening left free by the lower element (2).

3. The closure device in accordance with claim 1, characterized in that the lower element (2) is an adapter, which can be placed on a membrane-sealed neck of a container and which has a part extending upward over the container neck to form the pouring opening.

4. The closure device in accordance with claim 1, characterized in that the lower element (2) is designed as a part of the container itself.

5. The closure device in accordance with claim 1, characterized in that the lower element (2) and the piercing element (3) are two separately manufactured parts.

6. The closure device in accordance with claim 1, characterized in that the lower element (2) and the piercing element (3) are produced in one piece and arranged axially aligned on top of each other, and are maintained at an angular position by means of predetermined breaking points.

7. The closure device in accordance with claim 1, characterized in that the means in the screw cap (4) for actuating the piercing element (3) is an annular wall (43), on whose outer surface at least one catch rib (45) is formed, which extends parallel with the axis of rotation of the annular wall.

8. The closure device in accordance with claim 1, characterized in that the piercing element (3) has at least one cutting edge (32).

9. The closure device in accordance with claim 1, characterized in that on its cutting edge (32) oriented toward the container, the piercing element (3) is provided with at least one perforating tooth (33).

10. The closure device in accordance with claim 6, characterized in that the piercing element (3) is arranged axially aligned above the lower element (2), and the predetermined breaking points are strips which are arranged as destructible connections between the lower cutting edge (32) of the piercing element directed toward the container, and the upper edge of the pouring spout (20).

11. The closure device in accordance with claim 5, characterized in that the piercing element (3) is arranged axially aligned below the pouring spout (29) of the lower element (2), and the predetermined breaking points in the form of strips are arranged as destructible connections between the upper edge of the piercing element (3) and the said lower edge of the pouring spout (20).

12. The closure device in accordance with claim 1, characterized in that the screw cap (4) has a security strip, which acts in the axial direction and engages a recess in the lower element (2).

13. The closure device in accordance with claim 12, characterized in that the recess is an annular groove in the cylindrical pouring spout (20).

14. The closure device in accordance with claim 8, characterized in that the cutting edge has three different effective areas, namely a first perforating area in the shape of at least one perforating tooth (33), which is adjoined on both sides by a cutting area (37), and that one area is designed as a displacement area (38), which pushes aside the partially cut container wall (F) or the membrane out of the area of the pouring opening without causing a separation from the container wall or the membrane.

15. The closure device in accordance with claim 1, characterized in that the screw cap (4) forms at least one diametrically extending wall, which is arranged on the inside of its cover face (40) and forms at least one axis-parallel catch rib (45).

16. The closure device in accordance with claim 1, characterized in that the positive connecting means at the cylindrical wall (30) of the piercing element (3) is a slideway which protrudes in a helical manner.

17. The closure device in accordance with claim 1, characterized in that the positive connecting means at the cylindrical pouring spout (20) is a helical guide curve cut into the wall of the pouring spout (20).

18. The closure device in accordance with claims 16 and 17, characterized in that the slideway and the guide curve lie flat on top of each other.
